(19) United States
(12) Patent Application Publication
(10) Pub. No.: US 2024/0248721 A1
(43) Pub. Date: Jul. 25, 2024

(54) OPERATION DISTRIBUTION ACROSS MULTIPLE PROCESSING CORES

(71) Applicant: Arm Limited, Cambridge (GB)

(72) Inventors: Rune HOLM, Oslo (NO); Alexander Eugene CHALFIN, Mountain View, CA (US); Elliot Maurice Simon ROSEMARINE, London (GB)

(21) Appl. No.: 18/414,230

(22) Filed: Jan. 16, 2024

Related U.S. Application Data
(60) Provisional application No. 63/440,244, filed on Jan. 20, 2023.

(51) Int. Cl. G06F 9/38

(52) U.S. Cl. CPC G06F 9/3838

(57) ABSTRACT

A method and apparatus for distributing operations for execution. Input data is received and is subdivided into portions, each comprising a first and second sub-portion. A first operation and a second operation are received. Dependencies between the first and second operations are identified. For each portion the first operation is issued for execution on the first sub-portion to produce a first output sub-portion, and completion is tracked. The first operation is issued for execution on the second sub-portion to produce a second output sub-portion. Depending upon satisfaction of the dependencies in respect of the first sub-portion, either the second operation to be executed on the first output sub-portion is issued, if the dependencies are met; or the second operation, to be executed on the first output sub-portion is stalled, if the dependencies are not met. This is repeated for each subsequent portion.

### CROSS-REFERENCE TO RELATED APPLICATIONS

This application claims the benefit of U.S. Provisional Application No. 63/440,244, filed Jan. 20, 2023, under 35 U.S.C. § 119(a). Each of the above-referenced patent applications is incorporated by reference in its entirety.

### BACKGROUND OF THE INVENTION

### Field of the Invention

The present invention relates to methods, processors, and non-transitory computer-readable storage media for distributing operations for execution across, in particular handling the distribution of operations across multiple processing cores.

### Description of the Related Technology

Certain processing techniques, such as neural network processing and graphics processing, involve the processing and generation of considerable amounts of data using operations. It is desirable to efficiently handle the processing of this data by distributing operations across multiple processing cores efficiently.

### SUMMARY

According to a first aspect of the present invention, there is provided a method of distributing operations for execution comprising receiving input data, the input data being subdivided into a plurality of portions, each portion comprising at least a first and second sub-portion; receiving at least a first operation and a second operation, the first operation to operate on the input data; identifying dependencies between the first operation and the second operation, the dependencies comprising at least the second operation to operate on at least a portion of the output of the first operation; and for each of the plurality of portions issuing for execution, across one or more processing cores, the first operation on the first sub-portion to produce a first output sub-portion, and tracking completion of the execution; issuing, across the one or more processing cores, the first operation for execution on the second sub-portion to produce a second output sub-portion; and depending upon satisfaction of the dependencies between the first operation and the second operation in respect of the first sub-portion, either issuing the second operation to be executed, across the one or more processing cores, on the first output sub-portion if the dependencies are met; or stalling, at a command processing unit, the second operation, to be executed on the first output sub-portion, if the dependencies are not met; and repeating for each subsequent portion.

According to a second aspect of the present invention, there is provided a processor for the distribution of operations for execution by a processor, comprising input circuitry configured to receive at least input data, the input data being subdivided into a plurality of portions, each portion comprising at least a first and second sub-portion ; command processing circuitry to receive, from a host processor, at least a first operation and a second operation, the first operation to operate on the input data; dependency tracking circuitry for identifying dependencies between the first operation and the second operation, the dependencies comprising at least the second operation to operate on the output of the first operation; one or more processing cores to execute, for each portion, at least one of the first operation or the second operation on a given sub-portion associated with one of the plurality of portions, and to notify the dependency tracking circuitry of the completion of the execution; wherein the command processing circuitry issues for execution across the one or more processing cores, the first operation on the first sub-portion to produce a first output-sub portion, and tracks completion of the execution; issues, across the one or more processing cores, the first operation for execution on the second sub-portion to produce a second output sub-portion; and depending upon satisfaction of the dependencies between the first operation and the second operation in respect of the first sub-portion, either issuing the second operation to be executed, across the one or more processing cores, on the first output sub-portion if the dependencies are met; or stalling, at the command processing unit, the second operation, to be executed, across the one or more processing cores, on the first output sub-portion, if the dependencies are not met.

According to a third aspect of the present invention, there is provided a non-transitory computer-readable storage medium comprising a set of computer-readable instructions stored thereon which, when executed by at least one processor are arranged to distribute operations for execution, wherein the instruction when executed cause the at least one processor to receive input data, the input data being subdivided into a plurality of portions, each portion comprising at least a first and second sub-portion; receive at least a first operation and a second operation, the first operation to operate on the input data; identify dependencies between the first operation and the second operation, the dependencies comprising at least the second operation to operate on at least a portion of the output of the first operation; and for each of the plurality of portions issue for execution, across one or more processing cores, the first operation on the first sub-portion to produce a first output sub-portion, and tracking completion of the execution; issue, across the one or more processing cores, the first operation for execution on the second sub-portion to produce a second output sub-portion; and depending upon satisfaction of the dependencies between the first operation and the second operation in respect of the first sub-portion, either issue the second operation to be executed, across the one or more processing cores, on the first output sub-portion if the dependencies are met; or stall, at a command processing unit, the second operation, to be executed on the first output sub-portion, if the dependencies are not met; and repeat for each subsequent portion.

### BRIEF DESCRIPTION OF THE DRAWINGS

Further features and advantages will become apparent from the following description of preferred embodiments, given by way of example only, which is made with reference to the accompanying drawings in which like reference numerals are used to denote like features.

FIG. 1 is a flowchart of a method for handling the distribution of operations for execution across one or more processing cores according to an example;

FIG. 2 is a schematic representation of input data split into a plurality of volumes and sub-volumes according to an example;

FIG. 3 is a schematic representation of a processor for handling the distribution of operations for execution across one or more processing cores according to an example;

FIG. 4 is a schematic diagram of a data processing system for handling the distribution of operations, according to an example;

FIG. 5 is a schematic diagram of a neural engine according to an example; and

FIG. 6 is a schematic diagram of a system comprising features according to an example.

### DETAILED DESCRIPTION OF CERTAIN INVENTIVE EMBODIMENTS

Examples herein relate to a method for distributing operations for execution across one or more processing cores. Input data which is subdivided into a plurality of portions, each portion having at least a first and a second sub-portion is received. First and second operations are also received wherein the first operation is configured to operate on the input data. Dependencies between the first operation and the second operation are also identified, and in particular, comprise at least the second operation is configured to operate on at least a portion of the output of the first operation. For each of the plurality of portions, the first operation is issued for execution across the one or more processing cores, on the first sub-portion to produce a first output sub-portion, and completion of the execution is tracked. Furthermore, the first operation is issued across the one or more processing cores for execution on the second sub-portion to produce a second output sub-portion. Depending on the satisfaction of the dependencies between the first and second operations in respect of the first sub-portion, either the second operation is issued to be executed across the one or more processing cores on the first output sub-portion when the dependencies are met, otherwise the second operation is stalled at a command processing unit when the dependencies are not met. This process is then repeated for each subsequent portion of the input data.

With this approach, the method, when handling operations can minimize processor downtime, and increases efficiency. By tracking the dependencies between the first and second operations, the operations can be independently executed on a given sub-portion, and then the operation can be executed output of that execution, such that there is no need to delay the processing of an entire portion. As such, each sub-portion and the associated output after execution can be processed by a given operation, without the need to wait for the completion of the other sub-portion(s) associated with the given portion of the input data. This maximizes the resource usage and reducing processor core downtime.

The input data may be a tensor comprising at least two dimensions. This enable the input data to be efficiently split into a number of portions, such as in along a given dimension of the tensor, thereby enabling efficient handling and processing by the operations.

Optionally, the plurality of portions of input data may have a given size based on at least one characteristic associated with at least one of the one or more processing cores. The characteristics may include the size of a local cache associated with at least one of the one or more processing cores. This ensures optimal distribution of the operations for execution of the input data using the one or more processing cores, thereby maximising resource usage whilst reducing processor core downtime.

The size of a given portion of the input data and/or any intermediary data may be adjusted based on the execution of the operation on one or more preceding portions of the input data. This ensures that the most efficient allocations and/or portion size are used based on the capabilities of the processing cores and the outputs of any preceding operations, such as a pooling operation which reduces the data size. This further ensures maximum efficiency and resource usage.

The characteristics may be based on a type associated with the first operation or the second operation, which may be any one of an element-wise operation, a convolution operation, a reduction operation, a transform operation, a resize operation, or a pooling operation. Sizing each of the portions in accordance with the type of operation maximizes the resource usage, by sizing them in accordance with the available characteristics of the processing cores, such as the local cache size, whilst taking into account the likelihood of a larger or smaller output portion when processed by a given operation.

Optionally, at least one of the first operation and the second operation comprises a plurality of tasks. A first task of the plurality of tasks may be executed by a first processing core of the one or more processing cores, and a second task of the plurality of tasks may be executed by a second processing core of the one or more processing cores. This enables tasks within the operation to be divided up for processing on the one or more processing cores such that resource usage is maximized whilst processing core downtime is minimized.

Identifying dependencies between the first operation and the second operation may comprise allocating, by the command processing unit, a scoreboard to a first task of the plurality of tasks of the first operation, and a first task of the plurality of jobs tasks of the second operation to indicate a dependency between the first task of the first operation and the first task of the second operation. This enables dependencies between the tasks to be tracked such that sub-portions of the input data can be processed efficiently, and quickly so as to minimize any potential processing core downtime.

According to a second example, there is provided a processor for the distribution of operations for execution by a processing core. The processor comprises input circuitry configured to receive at least input data which has been subdivided into a plurality of portions, each portion comprising at least a first and second sub-portion. The processor also comprises command processing circuitry to receive, from a host processor, at least a first operation and a second operation, where the first operation is configured to operate on the input data. Dependency tracking circuitry then identifies dependencies between the first operation and the second operation, wherein the dependencies comprise at least the second operation being configured to operate on the output of the first operation. The processor comprises a one or more processing cores for executing, for each of the plurality of portions, at least one of the first operation or the second operation on a given sub-portion associated with one of the plurality of portions, and to notify the dependency tracking circuitry of the completion of the execution. The command processing circuitry issues for execution across the one or more processing cores, the first operation on the first sub-portion to produce a first output-sub portion, and tracks completion of the execution. It also issues, across the one or more processing cores, the first operation for execution on the second sub-portion to produce a second output sub-portion. Depending upon satisfaction of the dependencies between the first operation and the second operation in respect of the first sub-portion the command processing circuitry, either issues the second operation to be executed, across the one or more processing cores, on the first output sub-portion if the dependencies are met; or stalls, at the command processing unit, the second operation, to be executed, across the one or more processing cores, on the first output sub-portion, if the dependencies are not met.

With this approach, the method, when handling operations can minimize processor downtime, and increases efficiency. By tracking the dependencies between the first and second operations, the operations can be independently executed on a given sub-portion, and then the operation can be executed output of that execution, such that there is no need to delay the processing of an entire portion. As such, each sub-portion and the associated output after execution can be processed by a given operation, without the need to wait for the completion of the other sub-portion(s) associated with the given portion of the input data. This maximizes the resource usage and reducing processor core downtime.

According to a third example, there is provided a non-transitory computer-readable storage medium comprising a set of computer-readable instructions stored thereon which, when executed by at least one processor are arranged to distribute operations for execution. The instructions when executed cause the at least one processor to receive input data that is subdivided into a plurality of portions, each portion comprising at least a first and second sub-portion. At least a first operation and a second operation, the first operation to operate on the input data are also received. Dependencies between the first operation and the second operation are identified, the dependencies comprising at least the second operation to operate on at least a portion of the output of the first operation. Then for each of the plurality of portions, the first operation is issued for execution, across one or more processing cores, on the first sub-portion to produce a first output sub-portion, and completion of the execution is tracked. The first operation is also issued, across the one or more processing cores, in accordance with the second sub-portion, to produce a second output sub-portion. Depending on the satisfaction of the dependencies between the first and second operations in respect of the first sub-portion, either the second operation is issued to be executed across the one or more processing cores on the first output sub-portion when the dependencies are met, otherwise the second operation is stalled at a command processing unit when the dependencies are not met. This process is then repeated for each subsequent portion of the input data.

With this approach, the method, when handling operations can minimize processor downtime, and increases efficiency. By tracking the dependencies between the first and second operations, the operations can be independently executed on a given sub-portion, and then the operation can be executed output of that execution, such that there is no need to delay the processing of an entire portion. As such, each sub-portion and the associated output after execution can be processed by a given operation, without the need to wait for the completion of the other sub-portion(s) associated with the given portion of the input data. This maximizes the resource usage and reduces processor core downtime.

### Distribution of Operations

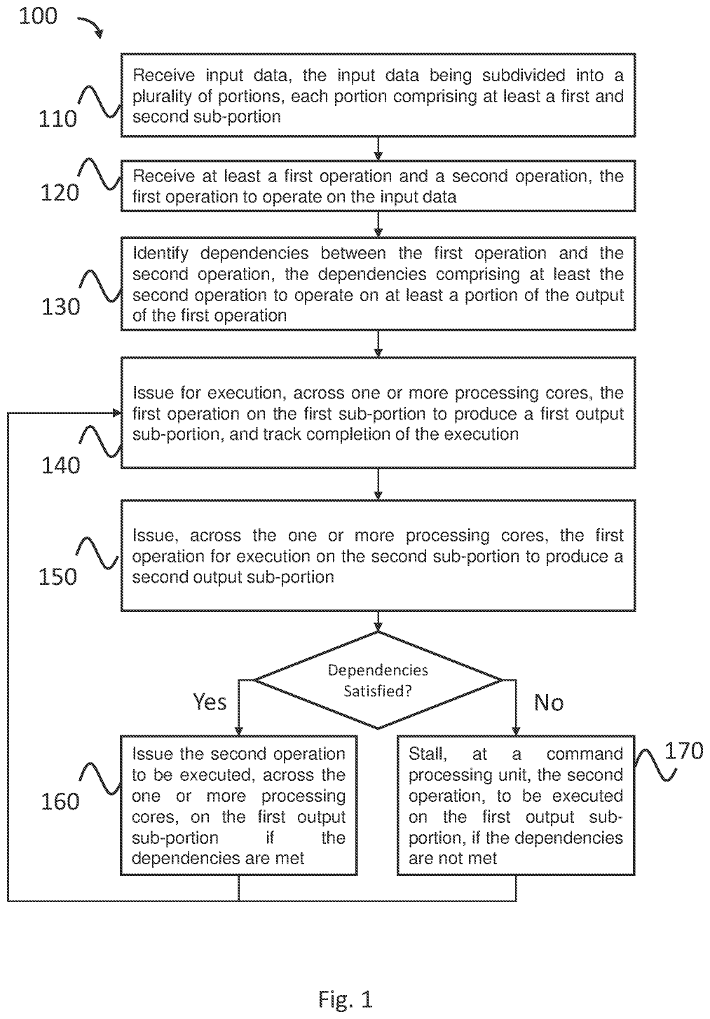

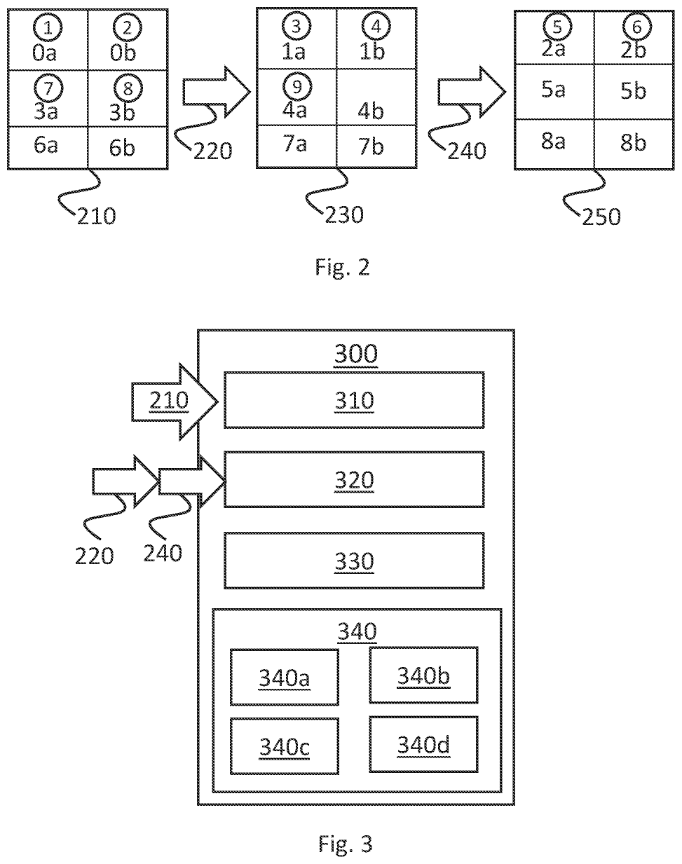

FIG. 1 is a flowchart of a method 100 for handling data for processing such as for processing by processor 300 described below in relation to FIG. 3. At step 110, input data is received. The input data, such as input data 210 in FIG. 2 may be a tensor. Whilst the input data 210 is shown to be a two-dimensional tensor, it will be appreciated that tensors with greater than two, or even a single dimension may be used. The input data 210 as shown in FIG. 2 has two dimensions, and it's operation space is split into a number of stripes/portions. Whilst the input data 210 is split into three portions 0, 3, 6 in the or horizontal dimension in FIG. 2, it will be appreciated that the input data 210 may be split into any number of portions. Similarly, in three-dimensional or higher tensor data the portions/stripes may be split into portions in any dimension of the tensor.

Furthermore, each portion/stripe of the input data 210 is also split into a plurality of sub-portions/sub-stripes 0a, 0b, 2a, 2b, etc. In some examples, each sub-portion may also be split into a plurality of tasks for execution on multicore processors as will be described in further detail below. It will be appreciated that portions may be split into sub-portions in any dimension, including the same dimension as the input data is split into portions.

The split of the of the input data 210 into portions and sub-portions may be defined by the operations 220, 240 performed on the input data 210 as will be described in further detail below. For example, in elementwise operations, there is no dependency from the input of the operation to the output of the operation other than a 1-to-1 relationship. In other operations, such as a convolution and/or pooling, there is a field of influence in a given dimension. For example, in a 3×3 kernel, each output element is affected by a surrounding field of input elements in the height and width dimensions. When a split occurs for a dimension affected by an operation's field of influence, then the split must change as we progress the chain of operations 220, 240. Assuming a processing order that starts at the top-left, and with a 3×3 convolution example, the right-most and bottom-most elements of a (sub-)portion is dependent on the left-most and top-most (respectively) elements of different (sub-)portion, as shown in FIG. 2, the ‘height’ of the uppermost (sub-) portion(s) 0a,0b is greater than the ‘height’ of the uppermost (sub-)portion(s) 1a, 1b of the intermediary data 230. Given that we progress to the intermediary data 230 and continue to work on the same portion (and it's respective sub-portions), that data isn't available and so the size of the portion must decrease, with that edge processed later and the subsequent portions increasing. This results in a pattern where the first (sub-)portion 0a, 0b shrinks in size, all the subsequent portions 1a, 1b, remain the same size but move up/left by the amount the first shrank, and the final portion 7a, 7b increases in size by the corresponding amount. As this shift occurs for each operation in the cascade, the split of (sub-)portions ends up as a staircase pattern.

Whilst the example described above relates to convolution and/or pooling operations, it will be appreciated that a number of other types of operation may be used, such as a reduction operation, a transform operation, and/or a resize operation.

In some examples, to improve efficiency further, the sub-division of the input data into portions and/or sub-portions may be based on the size of a cache or other memory, such as a cache associated with one of the one or more processing cores. For example, with a 3×3 kernel we might want to staircase the input data (as described above) in a 1×1 pattern. However, the cache or other memory may have many different formats, such as 16-wide, 8-wide and 4-wide; all are 1-high, in this example, with depth varying to ensure they always represent a whole cache-line.

Therefore, rather than staircasing 1×1, we would staircase 1×16, 1×8 or 1×4, depending on the chosen brick format. It will be appreciated that other memory formats may be used and the same principle of subdividing the input data based on characteristics of the memory/cache also applies.

In some examples, such as where the operations are considered reduction operations, the operation has a field of influence that covers the entire span of a given dimension (or multiple dimensions) of the input data/tensor. Convolution operations, for example, are reduction operations in the input-channel dimension. In such examples, sub-portions splits in the reduction dimension may not be necessary or even possible.

By splitting the input data in such a way, each portion or sub-portion may be sized to fit into a processor's internal memory, this enables the results of any processing to be written to and read back to/from local memory, such as a cache. This removes the requirement for read/write operations to external memory which are resource intensive. This means that intermediate data, such as data 230 of FIG. 2, does not need to be written to the external memory, thereby eliminating large amounts of external memory traffic and reducing the cases where bandwidth limitations exist.

Following the receipt of the input data, at step 120, at least a first and second operation are received, such a first operation 220 and second operation 240 shown in FIG. 2. As described above, these operations may be of any type, such as an element-wise operation; a convolution operation; a reduction operation; a transform operation; a resize operation; and a pooling operation. At least the first of the operations 220 is configured to operate on the input data 210, whereas other operations may be configured to operate on other intermediary data 230, 250.

Before execution of the operations 220, 240 on the input data 230, dependencies between the first and the second operation are identified at step 130. For example, the second operation 240 may be dependent upon the output, i.e., the intermediary data 230 of the first operation 220. As the execution of the operations may occur on the (sub-)portions of the input data across one or more cores, it may be desirable to split each operation into a plurality of tasks. This enables all the processing cores to be executing the same sequence tasks for a given operation, on each of the different sub-portions at substantially the same time. This is because dispatch to the plurality of processing cores happens approximately at the same time, and even if a given processing core may run faster/slower than others due to memory latencies or differently sized sub-portions etc., they are all running substantially in unison.

By identifying the dependencies between the first operation 220 and the second operation 240, the sequence of operations 220, 240 (or tasks) may be arranged hierarchically. For example, a small number of tasks may be grouped together in one chain, and multiple of these chains may be grouped together to provide the full cascade of operations. The results of individual tasks may be isolated in core-local memory or a shared buffer, whereas the results of each chain are visible in processor-local memory, shared between cores within the same processor. In a classic GPU, the core-local memory can be considered akin to a core's register file, while the processor-local memory would be the GPU's L1/L2 cache/memory system (L1 may be core-private memory but coherent throughout the L2, and therefore visible to other cores).

Once dependencies between the operations have been determined, at step 140, the first operation 220 is issued for execution across the one or more processing cores, on the first sub-portion 0a of the input data 210. The execution of the first operation 220 on the first sub-portion 0a produces a first output sub-portion 1a. Similarly, at step 150 the first operation 220 is issued for execution across the one or more processing cores on the second sub-portion 0b, to produce a second output sub-portion 1b. At step 160, further operations, such as the second operation 240, may be issued for execution on a given output sub-portion 1a, 1b only when the dependencies identified at step 130 are satisfied for the operation being executed on the corresponding sub-portion 0a, 0b. If the dependencies are not satisfied, then the further operations 240 are stalled at a command processing unit, such as the command processing unit described below in relation to FIG. 3. This ensures that the operations can execute on each subsequent sub-portion without any issues, as the dependencies between the two sub-portions have been satisfied.

Once the given sub-portions of a given portion has been processed throughout the entirety of the chain of data, i.e., from the input data 210, through the intermediary data 230, and produced output data 250, steps 140 through 170 are repeated on the next portion. This ensures that the operations can be started without any issues: there are no dependencies between the two portions. When we start a new set of cascades (the next set of cascaded operations) then there is a dependency on the final output of the previous set of cascades. In a single-core system, because data is processed in order, this is a non-issue. Otherwise, we need some form of synchronization to indicate that the results from the previous cascade are available. But we only have a dependency on corresponding volumes, typically: the first volume of the new cascade is dependent on the output of the first volume of the prior cascade. If there are many volumes, this means that synchronization does not need to be efficient.

In neural networks, non-element-wise operations are common, such as a convolution operation with a kernel of size 3×3, which will have a dependency on the surrounding elements in the X and Y axes. In some examples, it is hard to make guarantees about dispatching subsequent chains of the same sub-portions to the same cores. Therefore, dependencies between the operations 220, 240 become a problem, hence the requirement to identify and track the dependencies. As these dependencies relate to different operations 220, 240, executing on one sub-portion, and its output, for the same portion, these dependencies require synchronization from one operation 220 to the next operation. 240.

This creates a situation where the processing cores become dependent on the data produced by other cores in their preceding chain of operations (e.g., sub-portion 1a being dependent on the processing of sub-portion 0a). If a core finishes one processing a chain for a sub-portion, it can't start processing the next chain for the same sub-portion (or any sub-portion from the portion) until it knows that the cores working on the previous chain for the surrounding sub-portion have finished processing.

When all sub-portions in each portion have been processed by the given operations, then step 140 through step 170 are repeated on the subsequent portion as there is no dependency between the first portion and its respective sub-portions 0a, 0b . . . 2a, 2b, and the second portion and it's respective sub-portions 3a, 3b . . . 5a, 5b. In a single-core system, because data is processed in order, this is a non-issue. However, in systems where data is processed by one or more processing cores, some form of synchronization is required to indicate that the results from the previous sub-portion are available.

In some examples, the dependencies and synchronization of processing cores may occur through the central control interface, such as a command processing unit, as will be described below with reference to FIG. 3. The command processing unit may have built-in scoreboard capabilities to track that all tasks (sub-portions for a specific operation (or part of an operation)) to indicate when they have been completed. Sub-portion may be representative of a job, which is further divided into tasks for distribution across cores. This division is a spatial division, and as such, a task is a sub-sub-portion. It is therefore desirable to track that all tasks for a given job/sub-portion have been completed. As the scoreboarding is oriented around the entire job, in effect the dependency for a given processing core to start the next operation now becomes that all the sub-portions have completed. Furthermore, since the scoreboarding is centralized, there are larger initial overheads introduced, that is there is a lot of preliminary work that a processing core can do for the next operation (or part of an operation such as a task) while execution is completing on the preceding sub-portion. The dependency and scoreboarding tracking means that it is not possible to tell the processing core about the next operation (or part thereof) until the dependent operations or tasks across all processing cores are finished, meaning that none of this preliminary work can be performed until all cores complete the previous operation. This creates time where processing cores are idle waiting for other processing cores to finish or while performing the preliminary work that was not able to be perform earlier.

This may be represented using the following schematic example:
(cascade0:) C0P0, C1P0, C2P0, C3P0
(cascade0:) C0P1, C1P1, C2P1, C3P1
(cascade0:) C0P2, . . .
(cascade0:) C0P3, . . .
(cascade1:) C4P0, . . .

Where a cascade is an operation applied to a set of portions, C is a chain or set of operations, and P is a portion of the input data. C0P1 has no dependencies, and therefore it is a choice to execute it after C3P0. In essence, CxPn can not be executed until C(x−1)Pn is complete. That is, the dependency is for the same portion on the previous chain.

Here for each of 4 groups of chains/jobs (C0-3) in the cascade (cascade0), successive operations are dependent on each other as we process a portion (Px) within this cascade. This may be implemented using a single scoreboard to track when all the tasks within each operation (CxPx) are complete, before issuing the next operation. There are no dependencies when we move to the next portion in the same cascade, but because we are tracking each operation individually, optimization is difficult and resource intensive. When we start the next cascade (cascade1; same volumes but a new group of task sC4 . . . ), there is a dependency from C4P0 to C3P0, but this does not need to be implemented because the existing use of the single scoreboard is sufficient to confirm C3P0 is complete.

The above example does not have pair-wise volumes, or sub-portions, it instead executes a set of chains/operations for a single portion.

In some examples, the execution pattern may be modified to be:
(cascade0:) C0P0, C0P1, C1P0, C1P1, C2P0, C2P1, C3P0, C3P1
(cascade0:) C0P2, C0P3, . . .
(cascade1:) C4P0, C4P1, . . .
(cascade1:) C4P2, C4P3, . . .

By alternate portions between successive operations, the successive operations are not dependent on each other, and so instead two scoreboards may be used, using alternate scoreboards for alternate jobs. CxP0 may use scoreboard A, while CxP1 may use scoreboard B. CxP2 and CxP3 can then reuse scoreboards A and B respectively. As such, it is possible to issue CxP1 to the processing cores while CxP0 is processing, as there is no dependency between them. This means the synchronization time is hidden under the processing time, and the preliminary work can also be completed in advance. As with the previous example, before a cascade (C3P1) is finished there is no dependency on this for the next job (C0P2), but again optimization is difficult and resource intensive. Furthermore, C4P0 would have a dependency on C3P0, but this would be covered by the existing scoreboarding usage.

To overcome and/or reduce some of these large overheads, a different implementation may be used. By rearranging operations to implement two sub-portions in one cascade, thus halving the number of iterations of a cascade: there are now only two instances of cascade0 rather than four. In reality, the total size of a cascade is determined by the size of the processor's internal memory, such as a GPU cache, and as describe above portions may be sized to fit the internal memory to eliminate the traffic to external memory. This is solved by instead halving the size of a portion as described above in relation to the generation of sub-portions. This results in two sub-portions in one cascade it is equivalent to the size of one portion in the old system. This in turn means the total number of (sub-)portions is doubled, and thus in practice there would still be four instances of cascade0 in these examples.

This results in an execution pattern of:
(cascade0:) C0P0a, C0P0b, C1P0a, C1P0b, C2P0a, C2P0b, C3P0a, C3P0b
(cascade0:) C0P1a, C0P1b, C1P1a, C1P1b, C2P1a, C2P1b, C3P1a, C3P1b
(cascade0:) C0P2a, C0P2b, . . .
(cascade0:) C0P3a, C0P3b, . . .
(cascade1:) C4P0a, C4P0b, . . .
(cascade1:) C4P1a, C4P1b, . . .
(cascade1:) C4P2a, C4P2b, . . .
(cascade1:) C4P3a, C4P3b, . . .

This is evidenced in the execution order shown in the circular identifiers associated with each sub-portion 0a, 0b, 1a, 1b, shown in FIG. 2.

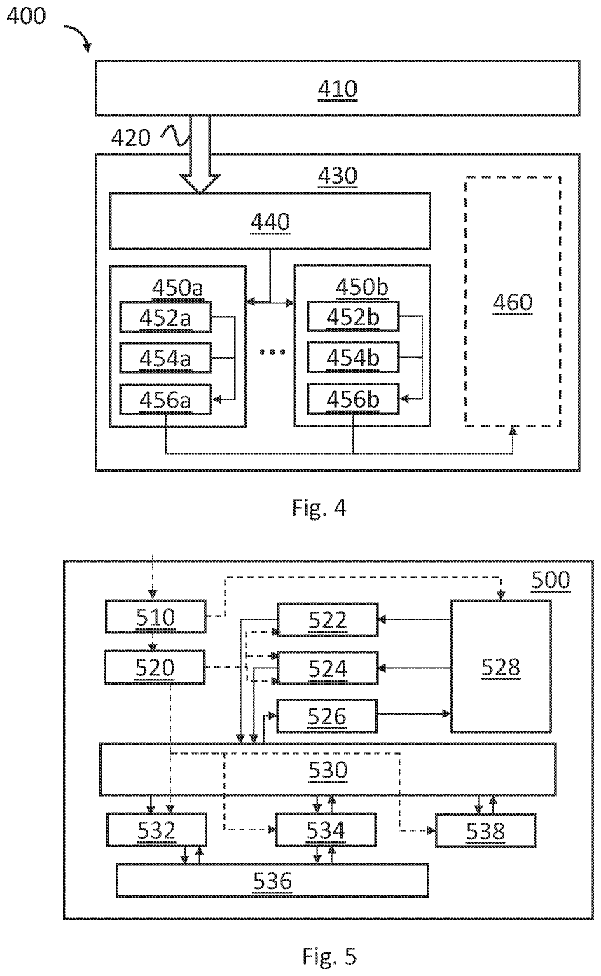

FIG. 3 is a schematic representation of a processor 300 handling the distribution of operations for execution across one or more processing cores. The processor 300 may be a processor which provides dedicated circuitry to perform the operations which would normally be undertaken by a dedicated hardware accelerator, such as a neural processing unit (NPU) and a graphics processing unit (GPU). FIG. 4, as described below shows an exemplary data processing system 400, including such a processor. It will be appreciated that the types of hardware accelerator for which the processor may provide dedicated circuitry for, is not limited to that of an NPU or a GPU, but may be dedicated circuitry for any type of hardware accelerator.

The processor 300 comprises input circuitry 310, configured to receive at least input data, the input data may be the input data 210 described above with reference to FIG. 2, and is subdivided into a plurality of portions, each portion comprising at least a first 0a and second sub-portion 0b. In some examples, the input data 210 may be obtained from storage (not shown). The storage may comprise a magnetic or optical disk and disk drive or a solid-state drive (SSD). In some examples, the storage comprises a synchronous dynamic random-access memory (SDRAM). For example, the storage may comprise a double data rate synchronous dynamic random-access memory (DDR-SDRAM). The input data 210 may be a tensor configured for use in a machine learning operation to be performed by a neural processing unit, such as the neural engine 500 described below with reference to FIG. 5.

The processor 300 also comprises command processing circuitry 320 configure to receive, from a host processor (not shown) at least a first operation 220 and a second operation 240. As described above, these operations may be of any type, such as an element-wise operation; a convolution operation; a reduction operation; a transform operation; a resize operation; and a pooling operation. At least the first of the operations 220 is configured to operate on the input data 210, whereas other operations may be configured to operate on other intermediary data 230, 250.

Dependency tracking circuitry 330 is also associated with the processor 300, and is configured to identify dependencies between at least the first operation 220 and the second operation. For example, the second operation 240 may be dependent upon the output, i.e., the intermediary data 230 of the first operation 220. Furthermore, as the execution of the operations may occur on the (sub-)portions of the input data across one or more cores, it may be desirable to split each operation into a plurality of tasks. This enables all the processing cores to be executing the same sequence tasks for a given operation, on each of the different sub-portions at substantially the same time. This is because dispatch to the plurality of processing cores happens approximately at the same time, and even if a given processing core may run faster/slower than others due to memory latencies or differently sized sub-portions etc., they are all running substantially in unison.

By identifying the dependencies between the first operation 220 and the second operation 240, the sequence of operations 220, 240 (or tasks) may be arranged hierarchically. For example, a small number of tasks may be grouped together in one chain, and multiple of these chains may be grouped together to provide the full cascade of an operation. The results of individual tasks may be isolated in core-local memory or a shared buffer, whereas the results of each chain are visible in processor-local memory, shared between cores within the same processor. In a classic GPU, the core-local memory can be considered akin to a core's register file, while the processor-local memory would be the GPU's L1/L2 cache/memory system (L1 is core-private memory but coherent throughout the L2, and therefore visible to other cores).

The processor 300 comprises a processing unit 340 comprising a plurality of processing cores 340a, 340b, 340c 340d. It will be appreciated that whilst the processing cores are shown to be part of a single processing unit, in some examples they may be independent of one another. The processing unit 340 is for executing operations on each of the sub-portions of the input data 210, obtained by the input circuitry 310 as described above. The processing of the input data 210 across the cores 340a . . . 340d of the processing unit 340 produces an output (not shown) which may be output for futher processing, such as by the host processor.

In some examples, the processor 300 may comprise a neural engine, such as the neural engine 400 described in further detail below with reference to FIG. 4. The neural engine may comprise a number of components configured to optimally process the input data 210 using the operations of the. For example, one of the processing cores 340a . . . 340d may comprise a vector engine configured to perform element-wise operations on the input data, and/or the neural engine may comprise a condition engine to perform matrix multiplication operations. As such, the neural engine, and as a result, the processing 300 may be configured to perform operations of any type efficiently. It will be appreciated that the processor 300 may comprise other processing units configured to perform other types of operations.

The processor 300, and the processing unit 340 and the associated processing cores 340a . . . 340d, in particular, are configured to perform the method steps 140 to 170 described above in relation to method 100 described in relation to FIG. 1.

### Exemplary Architecture for the Distribution of Operations

The methods described above may be used to process data of various types. For example, as explained above, the input data may be a tensor (where, as used herein, the term “tensor” is to be considered to refer to a multi-dimensional tensor). A tensor is an array of elements, such as an array of same-typed scalar elements. Various tasks may involve the processing and/or generation of tensors, such as neural network processing and graphics processing.

The methods herein may be implemented using a processor, such as processor 300, described above with reference to FIGS. 3, that provides dedicated circuitry that can be used to perform operations which would normally be undertaken by dedicated hardware accelerators, such as a neural processing unit (NPU) and a graphics processing unit (GPU). FIG. 4 shows schematically an example of a data processing system 400 including such a processor 430, which may comprise the components describe above in relation to processor 300 of FIG. 3. It will be appreciated that the types of hardware accelerator which the processor 430 may provide dedicated circuitry for is not limited to that of an NPU or GPU but may be dedicated circuitry for any type of hardware accelerator. GPU shader cores may be well-suited for performing certain types of arithmetic operations such as neural processing operations, as these operations are generally similar to the arithmetic operations that may be required when performing graphics processing work (but on different data). Furthermore, graphics processors typically support high levels of concurrent processing (e.g. supporting large numbers of execution threads), and are optimized for data-plane (rather than control plane) processing, all of which means that graphics processors may be well-suited for performing other types of operations.

That is, rather than using entirely separate hardware accelerators, such as a machine learning processing unit that is independent of the graphics processor, such as an NPU, or only being able to perform machine learning processing operations entirely using the hardware of the GPU, dedicated circuitry may be incorporated into the GPU itself.

This means that the hardware accelerator circuitry incorporated into the GPU is operable, to utilize some of the GPU's existing resources (e.g. such that at least some functional units and resource of the GPU can effectively be shared between the different hardware accelerator circuitry, for instance), whilst still allowing an improved (more optimized) performance compared to performing all the processing with general purpose execution.

As such, the processor 430 may be a GPU that is adapted to comprise a number of dedicated hardware resources, such as those which will be described below.

In some examples, this can be particularly beneficial when performing machine learning tasks that themselves relate to graphics processing work, as in that case all of the associated processing can be (and preferably is) performed locally to the graphics processor, thus improving data locality, and (e.g.) reducing the need for external communication along the interconnect with other hardware units (e.g. an NPU). In that case, at least some of the machine learning processing work can be offloaded to the machine learning processing circuit, thereby freeing the execution unit to perform actual graphics processing operations, as desired.

In other words, in some examples, providing a machine learning processing circuit within the graphics processor, this means that the machine learning processing circuit is preferably then operable to perform at least some machine learning processing operations whilst the other functional units of the graphics processor are simultaneously performing graphics processing operations. In the situation where the machine learning processing relates to part of an overall graphics processing task this can therefore improve overall efficiency (in terms of energy efficiency, throughput, etc.) for the overall graphics processing task.

In FIG. 4, the processor 430 is arranged to receive a command stream 420 from a host processor 410, such as a CPU. The command stream comprises at least one command in a given sequence, each command to be executed, and each command may be decomposed into a number of tasks, such as the tasks discussed in examples above. These tasks may be self-contained operations, such as a given machine learning operation or a graphics processing operation. It will be appreciated that there may be other types of tasks depending on the command.

The command stream 420 is sent by the host processor 410 and is received by a command processing unit 440 which is arranged to schedule the commands within the command stream 420 in accordance with their sequence. The command processing unit 440 is arranged to schedule the commands and decompose each command in the command stream 420 into at least one task. Once the command processing unit 440 has scheduled the commands in the command stream 420, and generated a plurality of tasks for the commands, the command processing unit issues each of the plurality of tasks to at least one compute unit 450a, 450b each of which are configured to process at least one of the plurality of tasks.

The processor 430 comprises a plurality of compute units 450a, 450b. Each compute unit 450a, 450b, may be a shader core of a GPU specifically configured to undertake a number of different types of operations, however it will be appreciated that other types of specifically configured processor may be used, such as a general-purpose processor configured with individual compute units, such as compute units 450a, 450b. Each compute unit 450a, 450b comprises a number of components, and at least a first processing module 452a, 452b for executing tasks of a first task type, and a second processing module 454a, 454b for executing tasks of a second task type, different from the first task type. In some examples, the first processing module 452a, 452b may be a processing module for processing neural processing operations, such as those which would normally be undertaken by a separate NPU. In these cases, the first processing module 452a, 452b is for example a neural engine. Similarly, the second processing module 454a, 454b may be a processing module for processing graphics processing operations forming a set of pre-defined graphics processing operations which enables the implementation of a graphics processing pipeline, which may be referred to as a graphics processor. For example, such graphics processing operations include a graphics compute shader task, a vertex shader task, a fragment shader takes, a tessellation shader task, and a geometry shader task. These graphics processing operations may all form part of a set of pre-defined operations as defined by an application programming interface, API. Examples of such APIs include Vulkan, Direct3D and Metal. Such tasks would normally be undertaken by a separate/external GPU. It will be appreciated that any number of other graphics processing operations may be capable of being processed by the second processing module.

As such, the command processing unit 440 issues tasks of a first task type to the first processing module 452a, 452b of a given compute unit 450a, 450b, and tasks of a second task type to the second processing module 454a, 454b of a given compute unit 450a, 450b. The command processing unit 440 would issue machine learning/neural processing tasks to the first processing module 452a, 452b of a given compute unit 450a, 450b where the first processing module 452a, 452b is optimized to process neural network processing tasks, for example by comprising an efficient means of handling a large number of multiply-accumulate operations. Similarly, the command processing unit 440 would issue graphics processing tasks to the second processing module 454a, 454b of a given compute unit 450a, 450b where the second processing module 452a, 454a is optimized to process such graphics processing tasks. In some examples, the first and second may both be neural processing tasks issued to a first processing module 452a, 452b, which is a neural engine. Such a neural processing task may involve the processing of a tensor, e.g. representing a feature map, with weights associated with a layer of a neural network.

In addition to comprising a first processing module 452a, 452b and a second processing module 454a, 454b, each compute unit 450a, 450b also comprises a memory in the form of a local cache 456a, 456b for use by the respective processing module 452a, 452b, 454a, 454b during the processing of tasks. The local cache 456a, 456b, may be the local memory described above with reference to processor 300 of FIG. 3. Examples of such a local cache 456a, 456b is a L1 cache. The local cache 456a, 456b may for example, a synchronous dynamic random-access memory (SDRAM). For example, the local cache 456a, 456b may comprise a double data rate synchronous dynamic random-access memory (DDR-SDRAM). It will be appreciated that the local cache 456a, 456b may comprise other types of memory.

The local cache 456a, 456b is used for storing data relating to the tasks which are being processed on a given compute unit 450a, 450b by the first processing module 452a, 452b and second processing module 454a, 454b. It may also be accessed by other processing modules (not shown) forming part of the compute unit 450a, 450b the local cache 456a, 456b is associated with. However, in some examples, it may be necessary to provide access data associated with a given task executing on a processing module of a given compute unit 450a, 450b to a task being executed on a processing module of another compute unit (not shown) of the processor 430. In such examples, the processor 430 may also comprise storage 460, for example a cache, such as an L2 cache, for providing access to data use for the processing of tasks being executed on different compute units 450a, 450b.

By providing a local cache 456a, 456b tasks which have been issued to the same compute unit 450a, 450b may access data stored in the local cache 456a, 456b, regardless of whether they form part of the same command in the command stream 420. The command processing unit 440 is responsible for allocating tasks of commands to given compute units 450a, 450b such that they can most efficiently use the available resources, such as the local cache 456a, 456b, thus reducing the number of read/write transactions required to memory external to the compute units 450a, 450b, such as the storage 460 (L2 cache) or higher level memories. One such example, is that a task of one command issued to a first processing module 452a of a given compute unit 450a, may store its output in the local cache 656a such that it is accessible by a second task of a different (or the same) command issued to a given processing module 452a, 454b of the same compute unit 450a.

One or more of the command processing unit 440, the compute units 450a, 450b, and the storage 460 may be interconnected using a bus. This allows data to be transferred between the various components. The bus may be or include any suitable interface or bus. For example, an ARM® Advanced Microcontroller Bus Architecture (AMBA®) interface, such as the Advanced eXtensible Interface (AXI), may be used.

FIG. 5 is a schematic diagram of a neural engine 500, which in this example is used as a first processing module 452a, 452b in a data processing system 400 in accordance with FIG. 4. The neural engine 500 includes a command and control module 510. The command and control module 510 receives tasks from the command processing unit 440 (shown in FIG. 4), and also acts as an interface to storage external to the neural engine 500 (such as a local cache 456a, 456b and/or a L2 cache 460) which is arranged to store data to be processed by the neural engine 500 such as data representing a tensor, or data representing a stripe of a tensor. The external storage may additionally store other data to configure the neural engine 500 to perform particular processing and/or data to be used by the neural engine 500 to implement the processing such as neural network weights.

The command and control module 510 interfaces to a handling unit 520, which is for example a traversal synchronization unit (TSU). In this example, each task corresponds to a stripe of a tensor, which is to be convolved with weights to implement a layer of a neural network. The tensor for example represents a feature map for processing using the neural network. A neural network typically includes a sequence of layers of processing, with an output from each layer being used as an input to the next layer. Each layer for example processes an input feature map by convolving the input feature map with a set of weights to generate an output feature map, which is used as the input feature map for the next layer. The term “feature map” is used generically herein to refer to either an input feature map or an output feature map. The processing performed by a given layer may be taken to correspond to an operation as described with reference to FIGS. 1 to 5.

In this example, the handling unit 520 splits data representing a stripe of a tensor into a plurality of blocks of data, each of which represents a respective part of the tensor. The handling unit 520 also obtains, from storage external to the neural engine 500 such as the L2 cache 460, an operation set comprising a plurality of operations. In this example, the operations are a chain of operations, representing a sequence of layers of the neural network. A block of data is allocated as an input to one of the operations by the handling unit 520.

The handling unit 520 coordinates the interaction of internal components of the neural engine 500, which include a weight fetch unit 522, an input reader 524, an output writer 526, a direct memory access (DMA) unit 528, a dot product unit (DPU) array 530, a vector engine 532, a transform unit 534, an accumulator buffer 536, and a storage 538, for processing of blocks of data. The data dependencies across the functional units are tracked by the handling unit 520. Processing is initiated by the handling unit 520 in a functional unit if all input blocks are available and space is available in the storage 538 of the neural engine 500. The storage 538 may be considered to be a shared buffer, in that various functional units of the neural engine 500 share access to the storage 538.

The weight fetch unit 522 fetches weights associated with the neural network from external storage and stores the weights in the storage 538. The input reader 524 reads data to be processed by the neural engine 500 from external storage, such as a block of data representing part of a tensor. The output writer 526 writes data obtained after processing by the neural engine 500 to external storage, such as a block of data representing part of an output feature map obtained by processing a corresponding part of an input feature map by the neural network represented by the weights fetched by the weight fetch unit 522. The weight fetch unit 522, input reader 524 and output writer 526 interface with the external storage (which is for example the local cache 456a, 456b, which may be a L1 cache such as a load/store cache) via the DMA unit 528.

The weights and block(s) of data are processed by the DPU array 530, vector engine 732 and transform unit 534 to generate output data which is written out to the external storage by the output writer 526. The DPU array 5730 is arranged to efficiently calculate a dot product between two operands, such as between an array of weights and a corresponding block of data (e.g. representing part of a tensor). The vector engine 532 is arranged to perform elementwise operations, for example to apply scale parameters to scale an output of a dot product calculated by the DPU array 530. Data generated during the course of the processing performed by the DPU array 530 and the vector engine 532 is stored temporarily in the accumulator buffer 536, from where it may be retrieved by either the DPU array 530 or the vector engine 532 for further processing as desired.

The transform unit 534 is arranged to perform in-block transforms such as dimension broadcasts or axis swaps. The transform unit 534 obtains data from the storage 538 (e.g. after processing by the DPU array 530 and/or vector engine 532) and writes transformed data back to the storage 538.

To make efficient use of the storage 538 available within the neural engine 500, the handling unit 520 determines an available portion of the storage 538, which is available during execution of part of a first task (e.g. during processing of a block of data associated with the first task by the DPU array 530, vector engine 532 and/or transform unit 534). The handling unit 520 determines a mapping between at least one logical address associated with data generated during execution of a second task (e.g. by processing of a block of data associated with the second task by the DPU array 530, vector engine 532 and/or transform unit 534) and at least one physical address of the storage 538 corresponding to the available portion. The logical address is for example a global address in a global coordinate system. Hence, by altering the physical address corresponding to a given logical address, the handling unit 520 can effectively control usage of the storage 538 without requiring a change in software defining the operation to be performed, as the same logical address can still be used to refer to a given element of the tensor to be processed. The handling unit 520 identifies the at least one physical address corresponding to the at least one logical address, based on the mapping, so that data associated with the logical address is stored in the available portion. The handling unit 520 can perform the mapping process according to any of the examples herein.

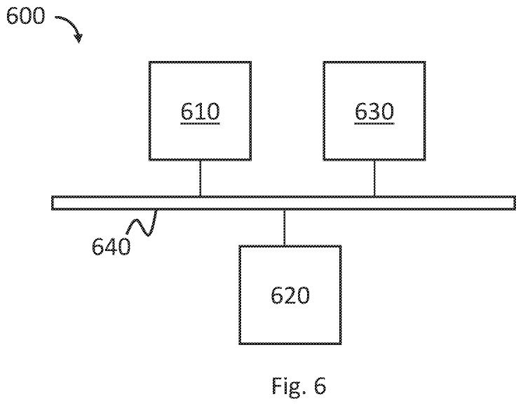

FIG. 6 shows schematically a system 600 for allocating handling data, and in some examples generating a plurality of blocks of input data for processing.

The system 600 comprises host processor 610 such as a central processing unit, or any other type of general processing unit. The host processor 610 issues a command stream comprising a plurality of commands, each having a plurality of tasks associated therewith.

The system 600 also comprises a processor 630, which may be similar to or the same as the processor 430 of FIG. 4, and may comprise at least some of the components of and/or be configured to perform the methods described above in relation to FIG. 1. The processor 630 comprises at least a plurality of compute units 450a, 450b and a command processing unit 440. Each compute unit may comprise a plurality of processing modules each configured to perform at least one type of operation. The system 600 may also include at least one further processor (not shown), which may be the same as the processor 630. The processor 630, and the host processor 610 may be combined as a System on Chip (SoC) or onto multiple SoCs to form one or more application processors.

The system 600 also comprises memory 620 for storing data generated by the tasks externally from the processor 630, such that other tasks operating on other processors may readily access the data. However, it will be appreciated that the external memory usage will be used sparingly, due to the allocation of tasks as described above, such that tasks requiring the use of data generated by other tasks, or requiring the same data as other tasks, will be allocated to the same compute unit 450a, 450b of a processor 630 so as to maximize the usage of the local cache 456a, 456b.

In some examples, the system 600 may comprise a memory controller (not shown), which may be a dynamic memory controller (DMC). The memory controller is coupled to the memory 620. The memory controller is configured to manage the flow of data going to and from the memory. The memory may comprise a main memory, otherwise referred to as a ‘primary memory’. The memory may be an external memory, in that the memory is external to the system 800. For example, the memory 620 may comprise ‘off-chip’ memory. The memory may have a greater storage capacity than local caches of the processor 630 and/or the host processor 610. In some examples, the memory 620 is comprised in the system 600. For example, the memory 620 may comprise ‘on-chip’ memory. The memory 620 may for example, comprise a magnetic or optical disk and disk drive or a solid-state drive (SSD). In some examples, the memory 620 comprises a synchronous dynamic random-access memory (SDRAM). For example, the memory 820 may comprise a double data rate synchronous dynamic random-access memory (DDR-SDRAM).

One or more of the host processor 610, the processor 630, and the memory 620 may be interconnected using a system bus 640. This allows data to be transferred between the various components. The system bus6840 may be or include any suitable interface or bus. For example, an ARM® Advanced Microcontroller Bus Architecture (AMBA®) interface, such as the Advanced eXtensible Interface (AXI), may be used.

At least some aspects of the examples described herein, with reference to FIGS. 1-6, comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

The above examples are to be understood as illustrative examples of the disclosure. Further examples of the disclosure are envisaged. It is to be understood that any feature described in relation to any one example may be used alone, or in combination with other features described, and may also be used in combination with one or more features of any other of the example, or any combination of any other of the examples. Furthermore, equivalents and modifications not described above may also be employed without departing from the scope of the disclosure, which is defined in the accompanying claims.

What is claimed is:

1. A method of distributing operations for execution comprising:
receiving input data, the input data being subdivided into a plurality of portions, each portion comprising at least a first and second sub-portion;
receiving at least a first operation and a second operation, the first operation to operate on the input data;
identifying dependencies between the first operation and the second operation, the dependencies comprising at least the second operation to operate on at least a portion of the output of the first operation; and
for each of the plurality of portions:
issuing for execution, across one or more processing cores, the first operation on the first sub-portion to produce a first output sub-portion, and tracking completion of the execution;
issuing, across the one or more processing cores, the first operation for execution on the second sub-portion to produce a second output sub-portion; and
depending upon satisfaction of the dependencies between the first operation and the second operation in respect of the first sub-portion, either:
issuing the second operation to be executed, across the one or more processing cores, on the first output sub-portion if the dependencies are met; or
stalling, at a command processing unit, the second operation, to be executed on the first output sub-portion, if the dependencies are not met; and
repeating for each subsequent portion.

2. The method of distributing operations for execution according to claim 1, wherein the input data is a tensor comprising at least two dimensions.

3. The method of distributing operations for execution according to claim 1, wherein the plurality of portions of input data each have a given size based on at least one characteristic associated with at least one of the one or more processing cores.

4. The method of distributing operations for execution according to claim 3, wherein the at least one characteristic comprises a size of a local cache associated with at least one of the one or more processing cores.

5. The method of distributing operations for execution according to claim 3, further comprising adjusting the given size of a given portion based on the execution of an operation on one or more preceding portions of the input data.

6. The method of distributing operations for execution according to claim 3, wherein the at least one characteristic is based on a type associated with at least one of the first operation or the second operation.

7. The method of distributing operations for execution according to claim 6, wherein the type is any one of:
an element-wise operation;
a convolution operation;
a reduction operation;
a transform operation;
a resize operation; and
a pooling operation.

8. The method of distributing operations for execution according to claim 1, wherein at least one of the first operation and the second operation comprise a plurality of tasks.

9. The method of distributing operations for execution according to claim 8, wherein a first task of the plurality of tasks is executed by a first processing core of the one or more processing cores, and a second task of the plurality of tasks is executed by a second processing core of the one or more processing cores.

10. The method of distributing operations for execution according to claim 8, wherein identifying dependencies between the first operation and the second operation comprises allocating, by the command processing unit, a scoreboard to a first task of the plurality of tasks of the first operation, and a first task of the plurality of tasks of the second operation to indicate a dependency between the first task of the first operation and the first task of the second operation.

11. A processor for the distribution of operations for execution by at least one processing core, comprising:
input circuitry configured to receive at least input data, the input data being subdivided into a plurality of portions, each portion comprising at least a first and second sub-portion;
command processing circuitry to receive, from a host processor, at least a first operation and a second operation, the first operation to operate on the input data;
dependency tracking circuitry for identifying dependencies between the first operation and the second operation, the dependencies comprising at least the second operation to operate on the output of the first operation;
one or more processing cores to execute, for each portion, at least one of the first operation or the second operation on a given sub-portion associated with one of the plurality of portions, and to notify the dependency tracking circuitry of the completion of the execution;
wherein the command processing circuitry:
issues for execution across the one or more processing cores, the first operation on the first sub-portion to produce a first output-sub portion, and tracks completion of the execution;
issues, across the one or more processing cores, the first operation for execution on the second sub-portion to produce a second output sub-portion; and
depending upon satisfaction of the dependencies between the first operation and the second operation in respect of the first sub-portion, either:
issuing the second operation to be executed, across the one or more processing cores, on the first output sub-portion if the dependencies are met; or
stalling, at the command processing unit, the second operation, to be executed, across the one or more processing cores, on the first output sub-portion, if the dependencies are not met.

12. The processor for the distribution of operations for execution according to claim 11, wherein the input data is a tensor comprising at least two dimensions.

13. The processor for the distribution of operations for execution according to claim 11, wherein the plurality of portions of input data each have a given size based on at least one characteristic associated with at least one of the one or more processing cores.

14. The processor for the distribution of operations for execution according to claim 13, wherein the at least one characteristic comprises a size of a local cache associated with at least one of the one or more processing cores.

15. The processor for the distribution of operations for execution according to claim 13, further comprises adjustment circuitry to adjust the given size of a given portion based on the execution of an operation on one or more preceding portions of the input data.

16. The processor for the distribution of operations for execution according to claim 13, wherein the at least one characteristic is based on a type associated with at least one of the first operation or the second operation.

17. The processor for the distribution of operations for execution according to claim 11, wherein the first and second operations comprise a plurality of tasks.

18. The processor for the distribution of operations for execution according to claim 17, wherein a first processing core of the one or more processing cores executes a first task of the plurality of tasks, and a second processing core of the one or more processing cores executes a second task of the plurality of tasks.

19. The processor for the distribution of operations for execution according to claim 17, wherein the dependency tracking unit allocates a scoreboard to a first task of the plurality of tasks of the first operation, and a first task of the plurality of tasks of the second operation to indicate a dependency between the first task of the first operation and the first task of the second operation.

20. A non-transitory computer-readable storage medium comprising a set of computer-readable instructions stored thereon which, when executed by at least one processor are arranged to distribute operations for execution, wherein the instruction when executed cause the at least one processor to:
receive input data, the input data being subdivided into a plurality of portions, each portion comprising at least a first and second sub-portion;
receive at least a first operation and a second operation, the first operation to operate on the input data;
identify dependencies between the first operation and the second operation, the dependencies comprising at least the second operation to operate on at least a portion of the output of the first operation; and
for each of the plurality of portions:
issue for execution, across one or more processing cores, the first operation on the first sub-portion to produce a first output sub-portion, and tracking completion of the execution;
issue, across the one or more processing cores, the first operation for execution on the second sub-portion to produce a second output sub-portion; and
depending upon satisfaction of the dependencies between the first operation and the second operation in respect of the first sub-portion, either:
issue the second operation to be executed, across the one or more processing cores, on the first output sub-portion if the dependencies are met; or
stall, at a command processing unit, the second operation, to be executed on the first output sub-portion, if the dependencies are not met; and
repeat for each subsequent portion.
